(19) United States
(12) Patent Application Publication
(10) Pub. No.: US 2025/0245501 A1
(43) Pub. Date: Jul. 31, 2025

(54) MULTI-TASK MODEL TRAINING METHODS AND APPARATUSES, AND ELECTRONIC DEVICES

(71) Applicant: Alipay (Hangzhou) Information Technology Co., Ltd., Hangzhou (CN)

(72) Inventors: Ningtao Wang, Hangzhou (CN); Yang YANG, Hangzhou (CN); Xing Fu, Hangzhou (CN); Weiqiang Wang, Hangzhou (CN)

(73) Assignee: Alipay (Hangzhou) Information Technology Co., Ltd., Hangzhou (CN)

(21) Appl. No.: 19/042,814

(22) Filed: Jan. 31, 2025

(30) Foreign Application Priority Data
Jan. 31, 2024 (CN) 202410137262.6

(51) Int. Cl. G06N 3/08

(52) U.S. Cl. CPC G06N 3/08

(57) ABSTRACT

Multi-task model training is described. Obtaining a trained multi-task model, where a parameter includes a basic parameter and a first branch parameter. Receiving an instruction for detecting output data of a question answering task branch. Adding a task detection branch to the multi-task model and obtaining a training corpus set. Training text is input into the multi-task model. Data corresponding to the first branch parameter of the question answering task branch is masked when data are generated at each neural network layer in the multi-task model and transferred to a next neural network layer to obtain a prediction result. A second branch parameter of the task detection branch is adjusted based on the label and the prediction result that corresponds to the training text to obtain a trained multi-task model.

### CROSS-REFERENCE TO RELATED APPLICATIONS

This application claims priority to Chinese Patent Application No. 202410137262.6, filed on Jan. 31, 2024, which is hereby incorporated by reference in its entirety.

### TECHNICAL FIELD

This specification relates to the field of data processing technologies, and in particular, to a multi-task model training methods and apparatuses, and electronic devices.

### BACKGROUND

With rapid development of technologies and applications such as the mobile Internet, digital media, and artificial intelligence (AI), information content on the Internet rapidly expands. However, the information is full of a large amount of bad information and information that reveals personal privacy. Various applications based on artificial intelligence may be attacked by data sample contamination, seriously affecting content security of Internet space. Therefore, a better multi-task model training solution urgently needs to be provided at present.

### SUMMARY

Embodiments of this specification provide multi-task model training methods and apparatuses, and electronic devices, to provide a better multi-task model training solution.

According to a first aspect, one or more embodiments of this specification provide a multi-task model training method, including: obtaining a trained multi-task model including at least a question answering task branch, where a parameter of the multi-task model includes a basic parameter and a first branch parameter corresponding to the question answering task branch, and the first branch parameter is a parameter for adjusting the basic parameter; when an instruction for detecting output data of the question answering task branch is received, adding a task detection branch to the multi-task model, and obtaining a training corpus set, where the training corpus set includes a plurality of training texts and a label that is of each training text and that corresponds to a prediction result of detection content in the instruction; inputting the training text into the multi-task model, and masking data corresponding to the first branch parameter of the question answering task branch when data are generated at each neural network layer in the multi-task model and transferred to a next neural network layer, to obtain a prediction result that corresponds to the training text and that is output by the task detection branch; and adjusting a second branch parameter of the task detection branch based on the label and the prediction result that correspond to the training text, to obtain a trained multi-task model, where the second branch parameter is a parameter for adjusting the basic parameter.

According to a second aspect, one or more embodiments of this application provide a multi-task model training apparatus, including: an acquisition module, configured to obtain a trained multi-task model including at least a question answering task branch, where a parameter of the multi-task model includes a basic parameter and a first branch parameter corresponding to the question answering task branch, and the first branch parameter is a parameter for adjusting the basic parameter; a branch module, configured to: when an instruction for detecting output data of the question answering task branch is received, add a task detection branch to the multi-task model, and obtain a training corpus set, where the training corpus set includes a plurality of training texts and a label that is of each training text and that corresponds to a prediction result of detection content in the instruction; a mask module, configured to: input the training text into the multi-task model, and mask data corresponding to the first branch parameter of the question answering task branch when data are generated at each neural network layer in the multi-task model and transferred to a next neural network layer, to obtain a prediction result that corresponds to the training text and that is output by the task detection branch; and an adjustment module, configured to adjust a second branch parameter of the task detection branch based on the label and the prediction result that correspond to the training text, to obtain a trained multi-task model, where the second branch parameter is a parameter for adjusting the basic parameter.

According to a third aspect, one or more embodiments of this application provide an electronic device. The electronic device includes: a processor; and a storage, configured to store computer-executable instructions. When the executable instructions are executed, the processor is enabled to perform the following operations: obtaining a trained multi-task model including at least a question answering task branch, where a parameter of the multi-task model includes a basic parameter and a first branch parameter corresponding to the question answering task branch, and the first branch parameter is a parameter for adjusting the basic parameter; when an instruction for detecting output data of the question answering task branch is received, adding a task detection branch to the multi-task model, and obtaining a training corpus set, where the training corpus set includes a plurality of training texts and a label that is of each training text and that corresponds to a prediction result of detection content in the instruction; inputting the training text into the multi-task model, and masking data corresponding to the first branch parameter of the question answering task branch when data are generated at each neural network layer in the multi-task model and transferred to a next neural network layer, to obtain a prediction result that corresponds to the training text and that is output by the task detection branch; and adjusting a second branch parameter of the task detection branch based on the label and the prediction result that correspond to the training text, to obtain a trained multi-task model, where the second branch parameter is a parameter for adjusting the basic parameter.

According to a fourth aspect, one or more embodiments of this specification provide a storage medium, configured to store a computer program. The computer program can be executed by a processor to implement the following procedure: obtaining a trained multi-task model including at least a question answering task branch, where a parameter of the multi-task model includes a basic parameter and a first branch parameter corresponding to the question answering task branch, and the first branch parameter is a parameter for adjusting the basic parameter; when an instruction for detecting output data of the question answering task branch is received, adding a task detection branch to the multi-task model, and obtaining a training corpus set, where the training corpus set includes a plurality of training texts and a label that is of each training text and that corresponds to a prediction result of detection content in the instruction; inputting the training text into the multi-task model, and masking data corresponding to the first branch parameter of the question answering task branch when data are generated at each neural network layer in the multi-task model and transferred to a next neural network layer, to obtain a prediction result that corresponds to the training text and that is output by the task detection branch; and adjusting a second branch parameter of the task detection branch based on the label and the prediction result that correspond to the training text, to obtain a trained multi-task model, where the second branch parameter is a parameter for adjusting the basic parameter.

### BRIEF DESCRIPTION OF DRAWINGS

To describe the technical solutions in one or more embodiments of this specification or in the existing technology more clearly, the following briefly describes the accompanying drawings needed for describing the embodiments or the existing technology. Clearly, the accompanying drawings in the following description merely show some embodiments recorded in one or more embodiments of this specification, and a person of ordinary skill in the art can still derive other drawings from these accompanying drawings without creative efforts.

FIG. 1 is a schematic flowchart illustrating a multi-task model training method, according to one or more embodiments of this specification;

FIG. 2 is a schematic diagram illustrating an application scenario of a multi-task model training method, according to one or more embodiments of this specification;

FIG. 3 is a schematic structural diagram illustrating a multi-task model training apparatus, according to one or more embodiments of this specification; and

FIG. 4 is a schematic structural diagram illustrating an electronic device, according to one or more embodiments of this specification.

### DESCRIPTION OF EMBODIMENTS

The following clearly and comprehensively describes technical solutions in one or more embodiments of this specification with reference to the accompanying drawings in the one or more embodiments of this specification. Clearly, described embodiments are some rather than all of the embodiments of this specification. All other implementations obtained by a person of ordinary skill in the art based on the implementations of this specification without creative efforts shall fall within the protection scope of this application.

In the specification and claims of this application, the terms such as “first” and “second” are intended to distinguish between similar objects but do not necessarily indicate a specific order or sequence. It should be understood that data used in this way can be interchangeable in a proper case, so that embodiments of this specification can be implemented in a sequence other than those shown or described here. Objects distinguished by “first” and “second” are usually of one type, and a quantity of objects is not limited. For example, there may be one first objects, or may be a plurality of first objects. In addition, in the specification and claims, “and/or” represents at least one of the connected objects, and the character “/” usually represents an “or” relationship between associated objects.

With reference to the accompanying drawings, the following describes in detail multi-task model training methods and apparatuses, and electronic devices provided in the embodiments of this specification by using specific embodiments and application scenarios thereof.

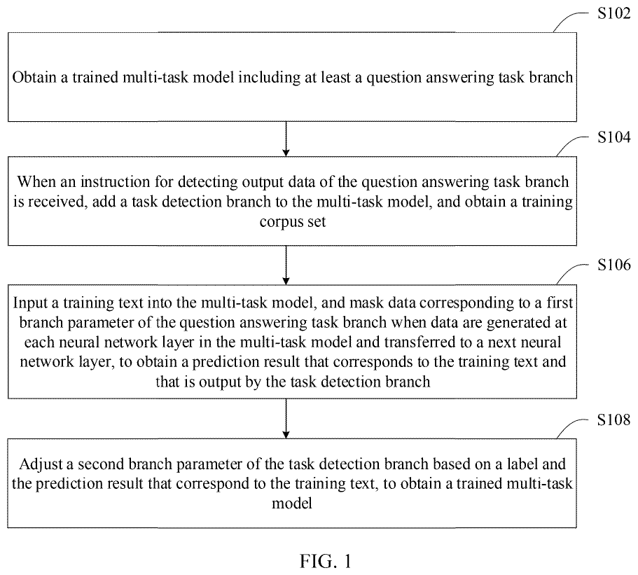

FIG. 1 shows a multi-task model training method according to one or more embodiments of this application. The method can be performed by an electronic device, and the electronic device can include a server and/or a terminal device. The terminal device can be, for example, a vehicle-mounted terminal or a mobile phone terminal. In other words, the method can be performed by software or hardware installed in the electronic device. The method includes the following steps.
S102: Obtain a trained multi-task model including at least a question answering task branch.

The multi-task model is a model obtained through expansion based on a general model obtained through pre-training. Specifically, one branch can be set in the multi-task model for each expanded task. For example, a model of a branch such as a question answering task can be set in the multi-task model. Each task branch is obtained through expansion based on the general model. Therefore, a parameter of the multi-task model can be set to a basic parameter corresponding to the general model and a branch parameter corresponding to each task branch. The branch parameter can be a parameter for adjusting the basic parameter. Further, the multi-task model can be enabled to execute each task based on the basic parameter and the branch parameter corresponding to each task branch.

In an example, the general model can be a large model whose model parameter exceeds a predetermined quantity threshold and/or complexity of a model structure exceeds a predetermined complexity threshold, for example, a large language model (LLM) or a multi-modal pre-training model. The large model is pre-trained based on a large-scale unmarked corpus, has more than 100 million parameters, can adapt to a wide range of downstream tasks, and has a good generalization capability. The task branch (for example, the question answering task branch) can correspond to various downstream tasks of the large model. After the large model is pre-trained, domain knowledge learned in a pre-training stage can be transferred to a specific downstream task only by performing fine-tuning on a small quantity of parameters of the large model based on a small amount of mark data, to improve the generalization capability of the model. The branch parameter can be used to represent an adjustment to the parameter of the large model. Specifically, the branch parameter corresponding to the question answering task branch can be a first branch parameter, and the first branch parameter can be a parameter for adjusting the basic parameter.
S104: When an instruction for detecting output data of the question answering task branch is received, add a task detection branch to the multi-task model, and obtain a training corpus set.

Because a quantity of branch parameters corresponding to each task branch is very small compared with a quantity of basic parameters, the quantity of branch parameters corresponding to each task branch is usually one thousand of the quantity of basic parameters. To avoid consuming a large quantity of computing resources and a large quantity of storage resources by creating a new model, when the instruction is received, the task detection branch can be added to the multi-task model by using a calculation capability of a general part of the multi-task model, and a training corpus is obtained, to perform task detection related training on the multi-task model, so that the multi-task model has a capability of detecting the output data of the question answering task branch. A branch parameter corresponding to the task detection branch can be a second branch parameter, and can be a parameter for adjusting the basic parameter.

Content output by the question answering task branch is not limited in this specification, and can be of a type such as a text, a picture, or a video. A type of a dataset required for training the task detection branch can be consistent with the type of the content output by the question answering task branch. To better describe the present disclosure and highlight essence of the present disclosure, in one or more specific embodiments of this specification, content output by a question answering task branch of a type of a text is used as a description object. A person skilled in the art should understand that, for content output by a question answering task branch of another type such as a picture or a video, the present disclosure can also be implemented. When the content output by the question answering task branch is of a type of a text, the training corpus set can include a training text and a label of the training text. The label of the training text is consistent with that of the detection content.

Detection content of the task detection branch can be content security, and can include aspects such as information content confidentiality, intellectual property protection, information hiding, and privacy protection. The detection content of the task detection branch is not specifically limited in this specification, and can be determined based on the received instruction. In an example, when the instruction includes a plurality of pieces of detection content, the training text can have a label corresponding to a prediction result of each piece of detection content.
S106: Input the training text into the multi-task model, and mask data corresponding to the first branch parameter of the question answering task branch when data are generated at each neural network layer in the multi-task model and transferred to a next neural network layer, to obtain a prediction result that corresponds to the training text and that is output by the task detection branch.

After the training corpus set is obtained, the training text in the training corpus set can be input into the multi-task model, to train the multi-task model. In a training process, to avoid interference to the task detection branch by another branch parameter such as the first branch parameter of the question answering task branch, the data corresponding to the first branch parameter can be masked before the data are generated based on the training text at each neural network layer in the multi-task model and the generated data are transferred to the next neural network layer, so that the data transferred to the next neural network layer is the same as data corresponding to a separate task detection model, and the task detection branch can output a detection result of the training text. When the multi-task model includes another task branch other than the question answering task branch, data corresponding to the question answering task branch can be masked through the same means, to mask data corresponding to the another task branch.
S108: Adjust a second branch parameter of the task detection branch based on the label and the prediction result that correspond to the training text, to obtain a trained multi-task model.

The second branch parameter can be a parameter for adjusting the basic parameter corresponding to the multi-task model.

In one or more embodiments of this specification, when the instruction for detecting the output data of the question answering task branch is received, a plurality of task branches are added to the multi-task model, and a parameter unrelated to the task detection branch in the multi-task model is masked, so that the multi-task model implements training of the task detection branch. In this process, a new detection model does not need to be deployed, and only the task detection branch is added to the multi-task model, to complete a task of detecting the output data of the question answering task branch. In this way, green deployment of the model is implemented, and computational and storage resources are greatly reduced. In addition, the first branch parameter is masked, so that training and use of different task branches do not affect each other, to avoid overfine-tuning on the model by implementing a plurality of types of performance by using the same model, and improve an effect of each task branch in the multi-task model.

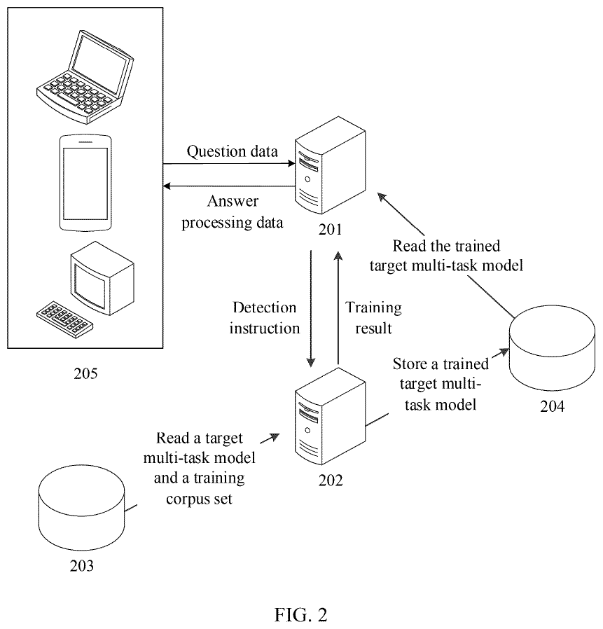

FIG. 2 is a schematic diagram of an application scenario of a multi-task model training method. As shown in FIG. 2, a multi-task model server 201 sends, to a multi-task model training server 202, a command for detecting data output by a target multi-task model. After receiving a model training command, the multi-task model training server 202 reads a target multi-task model and a training corpus set in a first database 203, trains the target multi-task model in the target multi-task model training method in this specification, returns a training result to the multi-task model server 201 after completing training, and stores the trained target multi-task model in a second database 204. Further, the multi-task model server 201 can read the trained target multi-task model from the second database 204 to answer question data sent by a client device 205, detect answer data to obtain answer processing data, and return the answer processing data to the client device 205.

In an implementation, step S106 can be performed as step A1 to step A3.
Step A1: Obtain a first mask vector corresponding to a second branch parameter.
Step A2: Perform, based on the first mask vector, a first mask operation on a parameter matrix including a branch parameter of each task branch in the multi-task model at each neural network layer, to mask a parameter matrix including a branch parameter other than the second branch parameter.
Step A3: Input a training text into the multi-task model obtained after the first mask operation is performed, to obtain a prediction result.

When data are generated at each neural network layer in the multi-task model and transferred to a next neural network layer, data corresponding to a first branch parameter of a question answering task branch is masked, which can mean that the first branch parameter is masked. Specifically, the first branch parameter can be masked based on a first mask vector. In the first mask vector, a to-be-masked branch parameter is different from a mask value corresponding to a to-be-reserved branch parameter.

In an example, a process of determining the first mask vector can be performed as step B1 to step B3.
Step B1: Determine a dimension of the first mask vector based on a quantity of task branches in the multi-task model.
Step B2: Determine a value corresponding to a task detection branch in the first mask vector as a first mask value.
Step B3: Determine a value other than the first mask value in the first mask vector as a second mask value.

Specifically, a mask value of the task detection branch and a mask value of another task branch are set to different mask values, to implement masking of a branch parameter of a task branch other than the task detection branch. For example, when there are two task branches in the multi-task model: the task detection branch and the question answering task branch, the first mask value and the second mask value can be respectively set to 0 and 1. In this case, the first mask vector can be [0, 1], and the first mask vector is multiplied by a matrix including a branch parameter (the matrix includes a parameter matrix corresponding to the task detection branch and a parameter matrix corresponding to the question answering task branch), to implement masking of the first branch parameter of the question answering task branch. Further, training of the task detection branch can be completed based on the second branch parameter that is of the task detection branch and that is reserved after masking.

In one or more embodiments of this specification, a branch parameter of a task branch unrelated to training of the task detection branch is masked based on the first mask vector, so that training of the task detection branch is implemented. Therefore, a task detection model and a question answering task model do not need to be simultaneously deployed, and a question answering task and a detection task can be completed by using only one multi-task model. In this way, green deployment of the model is implemented, and computational and storage resources are greatly reduced.

Although a quantity of branch parameters is smaller than a quantity of basic parameters, when the multi-task model is a large model, a parameter quantity of branch parameters required for model training is still relatively large, and a relatively large amount of computing time and computing resources are consumed. In an implementation, before the second branch parameter is adjusted, the multi-task model training method further includes: performing low-rank decomposition on a parameter matrix including the second branch parameter, to obtain a first parameter submatrix and a second parameter submatrix.

Low-rank decomposition can be decomposing a column rank of the second branch parameter. After low-rank decomposition, a quantity of rows of the first parameter submatrix is the same as a quantity of columns of the second parameter submatrix, a quantity of columns of the first parameter submatrix is the same as a quantity of columns of the parameter matrix, and a quantity of rows of the second parameter submatrix is the same as a quantity of rows of the parameter matrix. In this specification, the quantity of rows of the first parameter submatrix (namely, the quantity of columns of the second parameter submatrix) is not specifically limited, and can be determined based on an actual situation. Specifically, the quantity of rows of the first parameter submatrix needs to be less than the quantity of columns of the parameter matrix, and the quantity of rows of the first parameter submatrix needs to be less than the quantity of rows of the parameter matrix.

For example, low-rank decomposition is performed on a parameter matrix whose dimension is (100, 80), to obtain a first parameter submatrix whose dimension is (10, 80) and a second parameter submatrix whose dimension is (100, 10), and a quantity of parameters required for training is suddenly reduced from 8000 (=80*100) to 1800 (=100*10+10*80).

Similarly, in a training process of another task branch such as an answer task branch, the same low-rank decomposition method can also be used, to reduce a parameter quantity required in a training process of the multi-task model, improve training efficiency, and reduce consumption of computing resources and storage resources.

Further, after the first parameter submatrix and the second parameter submatrix are obtained, step A2 can be performed as step C1 and step C2.
Step C1: Multiply the first parameter submatrix by the second parameter submatrix, to obtain a product parameter matrix including the second branch parameter.
Step C2: Perform the first mask operation on a first parameter matrix and the product parameter matrix at each neural network layer in the multi-task model, to mask a parameter matrix including a branch parameter other than the product parameter matrix.

Specifically, in the training process, the first parameter submatrix and the second parameter submatrix can be multiplied, to obtain the product parameter matrix, and further, training of the task detection branch is implemented based on a parameter in the product parameter matrix.

In some embodiments of this specification, low-rank decomposition is performed, so that a parameter quantity required for training the task detection branch of the multi-task model is greatly reduced, and consumption of storage resources is reduced while a speed of training the multi-task model is improved.

In an implementation, adding the task detection branch to the multi-task model when an instruction includes a plurality of pieces of detection content includes: adding one task detection branch to the multi-task model.

Specifically, when the instruction includes detection of a plurality of types of prediction content of output data of the question answering task branch, if one task detection branch is added to each type of detection content, after training of each task branch is completed, when the multi-task model detects the plurality of types of prediction content for data, serial detection needs to be performed on the plurality of types of detection content for the data. In this way, time of obtaining a detection result by a user is prolonged, and user experience is reduced. In an example, one task detection branch can be set for the plurality of types of detection content, and the task detection branch can simultaneously detect the plurality of types of detection content for the data, to reduce detection time, and improve user experience.

In an implementation, after the trained multi-task model is obtained, the multi-task model training method further includes step D1 and step D2.
Step D1: Input question data into the multi-task model when the question data are received, and mask data corresponding to the second branch parameter when data are generated at each neural network layer in the multi-task model and transferred to the next neural network layer, to obtain answer data that correspond to the question data and that are output by the question answering task branch.
Step D2: Input the answer data into the multi-task model, and mask the data corresponding to the first branch parameter when data are generated at each neural network layer in the multi-task model and transferred to the next neural network layer, to obtain answer processing data that correspond to the answer data and that are output by the task detection branch.

Specifically, similar to a training process of the task detection branch, in a model reasoning process of the multi-task model, the data corresponding to the second branch parameter of the task detection branch at each neural network layer can be first masked to obtain the answer data corresponding to the question data, and then the data corresponding to the first branch parameter of the question answering task branch at each neural network layer is masked to obtain the answer processing data corresponding to the answer data, so that the multi-task model can output answer processing data that satisfy an expectation. For example, when the task detection branch performs content security detection on data output by the question answering task branch, the answer processing data are answer data that are for question data and that conform to content security; and when the task detection branch performs privacy detection on the data output by the question answering task branch, the answer processing data are an answer that is to the question data and that conforms to privacy security.

In an example, when the answer data are input into the multi-task model for detection to obtain the answer processing data, the question data can also be input into the multi-task model for detection, to expand a detection range and obtain a better detection result.

In an implementation, step D1 can be performed as step E1 to step E3.
Step E1: Obtain a second mask vector corresponding to the first branch parameter.
Step E2: Perform, based on the second mask vector, a second mask operation on a parameter matrix including a branch parameter of each task branch in the multi-task model at each neural network layer, to mask a parameter matrix including a branch parameter other than the first branch parameter.
Step E3: Input the question data into the multi-task model obtained after the second mask operation is performed, to obtain the answer data.

Specifically, similar to the training process of the task detection branch, when the question answering task branch is used to obtain the answer data corresponding to the question data, a parameter matrix of another task branch can be masked. In an example, a second mask vector corresponding to the answer task branch can be constructed, to implement masking of a parameter of a task branch other than the question answering task branch. For a construction process of the second mask vector, references can be made to a construction process of the first mask vector. Details are omitted here for simplicity.

Correspondingly, step D2 can be performed as step F1 and step F2.
Step F1: Perform, based on the first mask vector, a first mask operation on a parameter matrix including a branch parameter of each task branch in the multi-task model at each neural network layer, to mask a parameter matrix including a branch parameter other than the second branch parameter.
Step F2: Input the answer data into the multi-task model obtained after the first mask operation is performed, to obtain the answer processing data.

The following provides one or more embodiments of using the multi-task model after the multi-task model to which the task detection branch is added is trained. The multi-task model has a base model LLM, a fine-tuning version 0 for a question-answer pair (a question and an answer), and a fine-tuning version 1 for security detection. Steps of some embodiments are as follows:
Step 1: Input a question X raised by the user into the fine-tuning version 0, to generate an answer Y.
Step 2: Input the question and answer [X, Y] into the fine-tuning version 1, to generate a detection result, where there are two detection results: “secure” or “insecure”.
Step 3: Display the answer Y to the user if the detection result is “secure”; or display a management and control file to the user if the detection result is “insecure”.

In one or more embodiments of this specification, the data corresponding to the second branch parameter and the data corresponding to the first branch parameter are masked sequentially, to implement obtaining of the answer data corresponding to the question data and detection of the answer data, implement seamless cohesion of reasoning processes of different task branches of the multi-task model, and greatly improve a speed of model reasoning.

In an implementation, before the second mask operation is performed and the answer data are determined, the multi-task model training method further includes: inputting the question data into the multi-task model, and masking the data corresponding to the first branch parameter when data are generated at each neural network layer in the multi-task model and transferred to the next neural network layer, to obtain the question processing data that correspond to the answer data and that are output by the multi-task model.

Step D1 includes: inputting the question data into the multi-task model when the question processing data indicate that the question data satisfy a predetermined need, and masking the data corresponding to the second branch parameter when data are generated at each neural network layer in the multi-task model and transferred to the next neural network layer, to obtain the answer data that correspond to the question data and that are output by the question answering task branch.

Specifically, before the answer data corresponding to the question data are obtained, the question data can be first detected, and only when the question data satisfy the predetermined need, obtaining of the answer data and obtaining of the answer processing data in a next step are performed, to avoid wasting computing resources and time by performing next-step data processing when the question data do not satisfy the predetermined need.

It is worthwhile to note that the multi-task model training method provided in one or more embodiments of this specification can be performed by a multi-task model training apparatus, or a control module for performing the multi-task model training method in the multi-task model training apparatus. In one or more embodiments of this specification, the multi-task model training apparatus provided in one or more embodiments of this specification is described by using an example in which the multi-task model training apparatus performs the multi-task model training method.

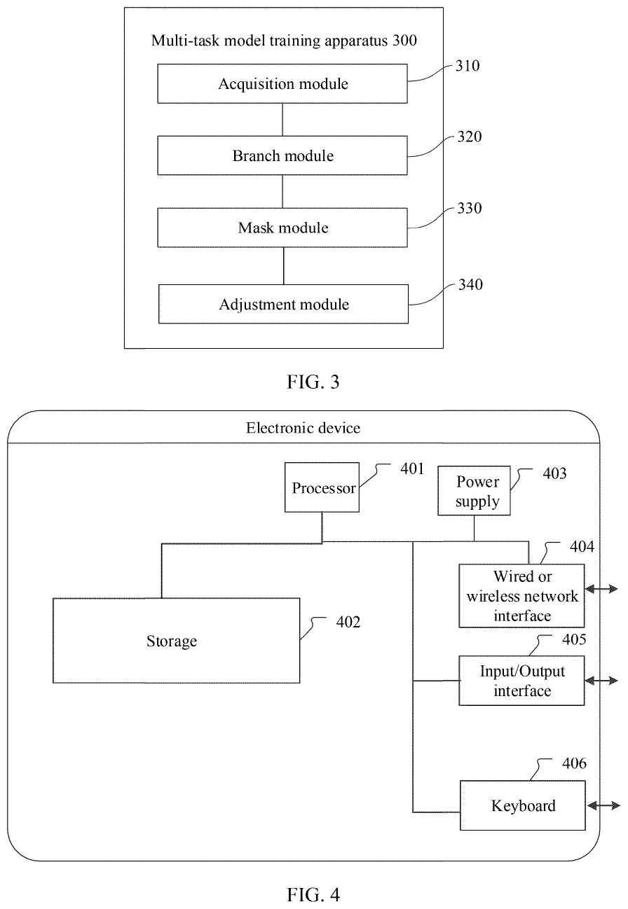

FIG. 3 is a schematic structural diagram illustrating a multi-task model training apparatus, according to one or more embodiments of this application. As shown in FIG. 3, a multi-task model training apparatus 300 includes: a model acquisition module 310, configured to obtain a trained multi-task model including at least a question answering task branch, where a parameter of the multi-task model includes a basic parameter and a first branch parameter corresponding to the question answering task branch, and the first branch parameter is a parameter for adjusting the basic parameter; a branch module 320, configured to: when an instruction for detecting output data of the question answering task branch is received, add a task detection branch to the multi-task model, and obtain a training corpus set, where the training corpus set includes a plurality of training texts and a label that is of each training text and that corresponds to a prediction result of detection content in the instruction; a mask module 330, configured to: input the training text into the multi-task model, and mask data corresponding to the first branch parameter of the question answering task branch when data are generated at each neural network layer in the multi-task model and transferred to a next neural network layer, to obtain a prediction result that corresponds to the training text and that is output by the task detection branch; and an adjustment module 340, configured to adjust a second branch parameter of the task detection branch based on the label and the prediction result that correspond to the training text, to obtain a trained multi-task model, where the second branch parameter is a parameter for adjusting the basic parameter.

In one or more embodiments, the mask module 330 includes: an acquisition unit, configured to obtain a first mask vector corresponding to the second branch parameter; a mask unit, configured to perform, based on the first mask vector, a first mask operation on a parameter matrix including a branch parameter of each task branch in the multi-task model at each neural network layer, to mask a parameter matrix including a branch parameter other than the second branch parameter; and a processing unit, configured to input the training text into the multi-task model obtained after the first mask operation is performed, to obtain the prediction result.

In one or more embodiments, the multi-task model training apparatus 300 further includes: a low-rank unit, configured to: before the second branch parameter is adjusted, perform low-rank decomposition on a parameter matrix including the second branch parameter, to obtain a first parameter submatrix and a second parameter submatrix, where a quantity of rows of the first parameter submatrix is the same as a quantity of columns of the second parameter submatrix, a quantity of columns of the first parameter submatrix is the same as a quantity of columns of the parameter matrix, and a quantity of rows of the second parameter submatrix is the same as a quantity of rows of the parameter matrix.

In one or more embodiments, the mask unit is configured to: multiply the first parameter submatrix by the second parameter submatrix, to obtain a product parameter matrix including the second branch parameter; and perform the first mask operation on a first parameter matrix and the product parameter matrix at each neural network layer in the multi-task model, to mask a parameter matrix including a branch parameter other than the product parameter matrix.

In one or more embodiments, when the instruction includes a plurality of pieces of prediction content, the branch module 320 includes: a branch unit, configured to add one task detection branch to the multi-task model.

In one or more embodiments, after the trained multi-task model is obtained, the multi-task model training apparatus 300 further includes: a first processing module, configured to input question data into the multi-task model when the question data are received, and masking data corresponding to the second branch parameter when data are generated at each neural network layer in the multi-task model and transferred to the next neural network layer, to obtain answer data that correspond to the question data and that are output by the question answering task branch; and a second processing module, configured to: input the answer data into the multi-task model, and mask the data corresponding to the first branch parameter when data are generated at each neural network layer in the multi-task model and transferred to the next neural network layer, to obtain answer processing data that correspond to the answer data and that are output by the task detection branch.

In one or more embodiments, before the second mask operation is performed and the answer data are determined, the multi-task model training apparatus 300 further includes: a third processing module, configured to: input the question data into the multi-task model, and mask the data corresponding to the first branch parameter when data are generated at each neural network layer in the multi-task model and transferred to the next neural network layer, to obtain the question processing data that correspond to the answer data and that are output by the multi-task model.

The first processing module includes: a first processing unit, configured to: input the question data into the multi-task model when the question processing data indicate that the question data satisfy a predetermined need, and mask the data corresponding to the second branch parameter when data are generated at each neural network layer in the multi-task model and transferred to the next neural network layer, to obtain the answer data that correspond to the question data and that are output by the question answering task branch.

In one or more embodiments, the first processing module includes: an acquisition unit, configured to obtain a second mask vector corresponding to the first branch parameter; a mask unit, configured to perform, based on the second mask vector, a second mask operation on a parameter matrix including a branch parameter of each task branch in the multi-task model at each neural network layer, to mask a parameter matrix including a branch parameter other than the first branch parameter; and a processing unit, configured to input the question data into the multi-task model obtained after the second mask operation is performed, to obtain the answer data.

The multi-task model training apparatus in one or more embodiments of this specification can be an apparatus, or can be a component, an integrated circuit, or a chip in the apparatus. The apparatus can be a mobile electronic device, or can be a non-mobile electronic device. For example, the mobile electronic device can be a mobile phone, a tablet computer, a laptop computer, a palmtop computer, a vehicle-mounted electronic device, a wearable device, an ultra-mobile personal computer (UMPC), a netbook, a personal digital assistant (PDA), etc. The non-mobile electronic device can be a server, a network attached storage (NAS), a personal computer (PC), a television (TV), a teller machine, a self-service machine, etc. This is not specifically limited in one or more embodiments of this specification.

The multi-task model training apparatus in one or more embodiments of this specification can be an apparatus with an operating system. The operating system can be an Android operating system, can be an iOS operating system, or can be another possible operating system. This is not specifically limited in some embodiments of this specification.

The multi-task model training apparatus provided in one or more embodiments of this specification can implement processes implemented in the method embodiment in FIG. 1. To avoid repetition, details are omitted here for simplicity.

Based on the same idea, one or more embodiments of this specification further provide an electronic device, as shown in FIG. 4. The electronic device can vary greatly due to a configuration or performance difference, and can include one or more processors 401 and a storage 402. The storage 402 can store one or more applications or data. The storage 402 can be a temporary storage or a persistent storage. The application stored in the storage 402 can include one or more modules (not shown in the figure), and each module can include a series of computer-executable instructions in the electronic device. Still further, the processor 401 can be configured to communicate with the storage 402 to execute a series of computer-executable instructions in the storage 402 on the electronic device. The electronic device can further include one or more power supplies 403, one or more wired or wireless network interfaces 404, one or more input/output interfaces 405, one or more keyboards 406, etc.

Specifically, in one or more embodiments, the electronic device includes the storage and one or more programs. The one or more programs are stored in the storage, and the one or more programs can include one or more modules, and each module can include a series of computer-executable instructions in the electronic device. The one or more processors are configured to execute the one or more programs, including computer-executable instructions, to perform the following operations: obtaining a trained multi-task model including at least a question answering task branch, where a parameter of the multi-task model includes a basic parameter and a first branch parameter corresponding to the question answering task branch, and the first branch parameter is a parameter for adjusting the basic parameter; when an instruction for detecting output data of the question answering task branch is received, adding a task detection branch to the multi-task model, and obtaining a training corpus set, where the training corpus set includes a plurality of training texts and a label that is of each training text and that corresponds to a prediction result of detection content in the instruction; inputting the training text into the multi-task model, and masking data corresponding to the first branch parameter of the question answering task branch when data are generated at each neural network layer in the multi-task model and transferred to a next neural network layer, to obtain a prediction result that corresponds to the training text and that is output by the task detection branch; and adjusting a second branch parameter of the task detection branch based on the label and the prediction result that correspond to the training text, to obtain a trained multi-task model, where the second branch parameter is a parameter for adjusting the basic parameter.

One or more embodiments of this specification further provide a storage medium. The storage medium stores one or more computer programs, the one or more computer programs include instructions, and when the instructions are executed by an electronic device including a plurality of applications, the electronic device can be enabled to perform various processes of the multi-task model training method embodiments, and is specifically configured to perform the following operations: obtaining a trained multi-task model including at least a question answering task branch, where a parameter of the multi-task model includes a basic parameter and a first branch parameter corresponding to the question answering task branch, and the first branch parameter is a parameter for adjusting the basic parameter; when an instruction for detecting output data of the question answering task branch is received, adding a task detection branch to the multi- task model, and obtaining a training corpus set, where the training corpus set includes a plurality of training texts and a label that is of each training text and that corresponds to a prediction result of detection content in the instruction; inputting the training text into the multi-task model, and masking data corresponding to the first branch parameter of the question answering task branch when data are generated at each neural network layer in the multi-task model and transferred to a next neural network layer, to obtain a prediction result that corresponds to the training text and that is output by the task detection branch; and adjusting a second branch parameter of the task detection branch based on the label and the prediction result that correspond to the training text, to obtain a trained multi-task model, where the second branch parameter is a parameter for adjusting the basic parameter.

The embodiments of this specification are described in a progressive way. For same or similar parts in the embodiments, references can be made to each other. Each embodiment focuses on a difference from another embodiment. Particularly, the storage medium embodiments are briefly described because they are basically similar to the method embodiments. For related parts, references can be made to related descriptions in some method embodiments.

The method, apparatus, module, or unit illustrated in the embodiments can be specifically implemented by a computer chip or an entity, or can be implemented by a product having a specific function. A typical implementation device is a computer. Specifically, for example, the computer can be a personal computer, a laptop computer, a cellular phone, a camera phone, a smart phone, a personal digital assistant, a media player, a navigation device, an e-mail device, a game console, a tablet computer, a wearable device, or any combination of these devices.

For ease of description, the above-mentioned apparatus is described by dividing functions into various units. Certainly, in implementing one or more embodiments of this specification, functions of units can be implemented in the same or more pieces of software and/or hardware.

A person skilled in the art should understand that one or more embodiments of this specification can be provided as methods, systems, or computer program products. Therefore, one or more embodiments of this specification can be a form of hardware only embodiments, software only embodiments, or embodiments with a combination of software and hardware. Furthermore, one or more embodiments of this specification can be used in a form of a computer program product implemented on one or more computer-usable storage media (including but not limited to a disk memory, a CD-ROM, an optical memory, etc.) including computer-usable program code.

One or more embodiments of this specification are described with reference to the flowcharts and/or block diagrams of the method, the device (system), and the computer program product based on the embodiments of this specification. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may be stored in a computer-readable memory that can instruct the computer or any other programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

The computer program instructions may alternatively be loaded onto a computer or another programmable data processing device, so that a series of operations and steps are performed on the computer or the another programmable device, so that computer-implemented processing is generated. Therefore, the instructions executed on the computer or the another programmable device provide steps for implementing a specific function in one or more procedures in the flowcharts and/or in one or more blocks in the block diagrams.

In a typical configuration, a computing device includes one or more processors (CPU), an input/output interface, a network interface, and a memory.

The memory may include a non-persistent memory, a random access memory (RAM), a nonvolatile memory, and/or another form that are in a computer-readable medium, for example, a read-only memory (ROM) or a flash memory (flash RAM). The memory is an example of the computer-readable medium.

The computer-readable medium includes persistent, non-persistent, movable, and unmovable media that can store information by using any method or technology. Information can be a computer-readable instruction, a data structure, a program module, or other data. Examples of the computer storage medium include but are not limited to a phase change random access memory (PRAM), a static random access memory (SRAM), a dynamic random access memory (DRAM), another type of RAM, a ROM, an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, another magnetic storage device, or any other non-transmission medium. The computer storage medium can be used to store information accessible by a computing device. Based on the definition in this specification, the computer-readable medium does not include transitory media such as a modulated data signal and carrier.

It is worthwhile to further note that the terms “include”, “contain”, or any other variant thereof are intended to cover a non-exclusive inclusion, so a process, a method, a product, or a device that includes a list of elements not only includes those elements but also includes other elements which are not expressly listed, or further includes elements inherent to such process, method, product, or device. Without more constraints, an element preceded by “includes a . . . ” does not preclude the existence of additional identical elements in the process, method, product or device that includes the element.

The one or more embodiments of this specification can be described in the general context of computer-executable instructions, for example, a program module. Usually, the program module includes a routine, a program, an object, a component, a data structure, etc. for executing a specific task or implementing a specific abstract data type. This specification can alternatively be practiced in distributed computing environments. In the distributed computing environments, tasks are executed by remote processing devices connected through a communication network. In a distributed computing environment, the program module can be located in both local and remote computer storage media including storage devices.

The embodiments of this specification are described in a progressive way. For same or similar parts in the embodiments, references can be made to each other. Each embodiment focuses on a difference from another embodiment. Particularly, some system embodiments are briefly described because they are basically similar to some method embodiments. For related parts, references can be made to related descriptions in some method embodiments.

The above-mentioned descriptions are merely one or more embodiments of this specification and are not intended for limiting this application. A person skilled in the art knows that one or more embodiments of this specification can have various modifications and changes. Any modifications, equivalent replacements, and improvements made within the spirit and principle of one or more embodiments of this specification shall fall within the scope of the claims in one or more embodiments of this specification.

What is claimed is:

1. A computer-implemented method for multi-task model training, comprising:
obtaining a trained multi-task model comprising at least a question answering task branch, wherein a parameter of the multi-task model comprises a basic parameter and a first branch parameter corresponding to the question answering task branch, and wherein the first branch parameter is a parameter for adjusting the basic parameter;
when an instruction for detecting output data of the question answering task branch is received:
adding a task detection branch to the multi-task model; and
obtaining a training corpus set, wherein the training corpus set comprises a plurality of training texts and a label that is of each training text and that corresponds to a prediction result of detection content in the instruction;
inputting training text into the multi-task model;
masking, to obtain a prediction result that corresponds to the training text and that is output by the task detection branch, data corresponding to the first branch parameter of the question answering task branch when data are generated at each neural network layer in the multi-task model and transferred to a next neural network layer; and
adjusting, to obtain a trained multi-task model, a second branch parameter of the task detection branch based on the label and the prediction result that corresponds to the training text, wherein the second branch parameter is a parameter for adjusting the basic parameter.

2. The computer-implemented method of claim 1, wherein;
inputting training text into the multi-task model; and masking, to obtain a prediction result that corresponds to the training text and that is output by the task detection branch, data corresponding to the first branch parameter of the question answering task branch when data are generated at each neural network layer in the multi-task model and transferred to a next neural network layer, comprises:
obtaining a first mask vector corresponding to the second branch parameter;
performing, based on the first mask vector and to mask a parameter matrix comprising a branch parameter other than the second branch parameter, a first mask operation on a parameter matrix comprising a branch parameter of each task branch in the multi-task model at each neural network layer; and
inputting, to obtain the prediction result, the training text into the multi-task model obtained after the first mask operation is performed.

3. The computer-implemented method of claim 2, wherein, before adjusting the second branch parameter:
performing, to obtain a first parameter submatrix and a second parameter submatrix, low-rank decomposition on a parameter matrix comprising the second branch parameter, wherein a quantity of rows of the first parameter submatrix is identical to a quantity of columns of the second parameter submatrix, a quantity of columns of the first parameter submatrix is identical to a quantity of columns of the parameter matrix, and a quantity of rows of the second parameter submatrix is identical to a quantity of rows of the parameter matrix.

4. The computer-implemented method of claim 3, wherein performing, based on the first mask vector, and to mask a parameter matrix comprising a branch parameter other than the second branch parameter, a first mask operation on a parameter matrix comprising a branch parameter of each task branch in the multi-task model at each neural network layer, comprises:
multiplying, to obtain a product parameter matrix comprising the second branch parameter, the first parameter submatrix by the second parameter submatrix; and
performing, to mask a parameter matrix comprising a branch parameter other than the product parameter matrix, the first mask operation on a first parameter matrix and the product parameter matrix at each neural network layer in the multi-task model.

5. The computer-implemented method of claim 1, wherein, when the instruction comprises a plurality of pieces of prediction content, adding a task detection branch to the multi-task model comprises:
adding one task detection branch to the multi-task model.

6. The computer-implemented method of claim 1, wherein, after obtaining a trained multi-task model:
when question data are received, inputting the question data into the multi-task model; and masking, to obtain answer data that correspond to the question data and that are output by the question answering task branch, data corresponding to the second branch parameter when data are generated at each neural network layer in the multi-task model and transferred to the next neural network layer; and
inputting the answer data into the multi-task model; and masking, to obtain answer processing data that correspond to the answer data and that are output by the task detection branch, the data corresponding to the first branch parameter when data are generated at each neural network layer in the multi-task model and transferred to the next neural network layer.

7. The computer-implemented method of claim 6, wherein, before a second mask operation is performed and the answer data are determined:
inputting the question data into the multi-task model, and masking, to obtain question processing data that correspond to the answer data and that are output by the multi-task model, the data corresponding to the first branch parameter when data are generated at each neural network layer in the multi-task model and transferred to the next neural network layer; and
inputting the question data into the multi-task model; and masking, to obtain answer data that correspond to the question data and that are output by the question answering task branch, data corresponding to the second branch parameter when data are generated at each neural network layer in the multi-task model and transferred to a next neural network layer, comprises:
when the question processing data indicates that the question data satisfy a predetermined need, inputting the question data into the multi-task model; and masking, to obtain the answer data that correspond to the question data and that are output by the question answering task branch, the data corresponding to the second branch parameter when data are generated at each neural network layer in the multi-task model and transferred to the next neural network layer.

8. The computer-implemented method of claim 6, wherein inputting the question data into the multi-task model; and masking, to obtain answer data that correspond to the question data and that are output by the question answering task branch, data corresponding to the second branch parameter when data are generated at each neural network layer in the multi-task model and transferred to the next neural network layer, comprises:
obtaining a second mask vector corresponding to the first branch parameter;
performing, based on the second mask vector and to mask a parameter matrix comprising a branch parameter other than the first branch parameter, a second mask operation on a parameter matrix comprising a branch parameter of each task branch in the multi-task model at each neural network layer; and
inputting, to obtain the answer data, the question data into the multi-task model obtained after the second mask operation is performed.

9. A non-transitory, computer-readable medium storing one or more instructions executable by a computer system to perform one or more operations for multi-task model training, comprising:
obtaining a trained multi-task model comprising at least a question answering task branch, wherein a parameter of the multi-task model comprises a basic parameter and a first branch parameter corresponding to the question answering task branch, and wherein the first branch parameter is a parameter for adjusting the basic parameter;
when an instruction for detecting output data of the question answering task branch is received:
adding a task detection branch to the multi-task model; and
obtaining a training corpus set, wherein the training corpus set comprises a plurality of training texts and a label that is of each training text and that corresponds to a prediction result of detection content in the instruction;
inputting training text into the multi-task model;
masking, to obtain a prediction result that corresponds to the training text and that is output by the task detection branch, data corresponding to the first branch parameter of the question answering task branch when data are generated at each neural network layer in the multi-task model and transferred to a next neural network layer; and
adjusting, to obtain a trained multi-task model, a second branch parameter of the task detection branch based on the label and the prediction result that corresponds to the training text, wherein the second branch parameter is a parameter for adjusting the basic parameter.

10. The non-transitory, computer-readable medium of claim 9, wherein;
inputting training text into the multi-task model; and masking, to obtain a prediction result that corresponds to the training text and that is output by the task detection branch, data corresponding to the first branch parameter of the question answering task branch when data are generated at each neural network layer in the multi-task model and transferred to a next neural network layer, comprises:
obtaining a first mask vector corresponding to the second branch parameter;
performing, based on the first mask vector and to mask a parameter matrix comprising a branch parameter other than the second branch parameter, a first mask operation on a parameter matrix comprising a branch parameter of each task branch in the multi-task model at each neural network layer; and
inputting, to obtain the prediction result, the training text into the multi-task model obtained after the first mask operation is performed.

11. The non-transitory, computer-readable medium of claim 10, wherein, before adjusting the second branch parameter:
performing, to obtain a first parameter submatrix and a second parameter submatrix, low-rank decomposition on a parameter matrix comprising the second branch parameter, wherein a quantity of rows of the first parameter submatrix is identical to a quantity of columns of the second parameter submatrix, a quantity of columns of the first parameter submatrix is identical to a quantity of columns of the parameter matrix, and a quantity of rows of the second parameter submatrix is identical to a quantity of rows of the parameter matrix.

12. The non-transitory, computer-readable medium of claim 11, wherein performing, based on the first mask vector, and to mask a parameter matrix comprising a branch parameter other than the second branch parameter, a first mask operation on a parameter matrix comprising a branch parameter of each task branch in the multi-task model at each neural network layer, comprises:
multiplying, to obtain a product parameter matrix comprising the second branch parameter, the first parameter submatrix by the second parameter submatrix; and
performing, to mask a parameter matrix comprising a branch parameter other than the product parameter matrix, the first mask operation on a first parameter matrix and the product parameter matrix at each neural network layer in the multi-task model.

13. The non-transitory, computer-readable medium of claim 9, wherein, when the instruction comprises a plurality of pieces of prediction content, adding a task detection branch to the multi-task model comprises:
adding one task detection branch to the multi-task model.

14. The non-transitory, computer-readable medium of claim 9, wherein, after obtaining a trained multi-task model:
when question data are received, inputting the question data into the multi-task model; and masking, to obtain answer data that correspond to the question data and that are output by the question answering task branch, data corresponding to the second branch parameter when data are generated at each neural network layer in the multi-task model and transferred to the next neural network layer; and
inputting the answer data into the multi-task model; and masking, to obtain answer processing data that correspond to the answer data and that are output by the task detection branch, the data corresponding to the first branch parameter when data are generated at each neural network layer in the multi-task model and transferred to the next neural network layer.

15. The non-transitory, computer-readable medium of claim 14, wherein, before a second mask operation is performed and the answer data are determined:
inputting the question data into the multi-task model, and masking, to obtain question processing data that correspond to the answer data and that are output by the multi-task model, the data corresponding to the first branch parameter when data are generated at each neural network layer in the multi-task model and transferred to the next neural network layer; and
inputting the question data into the multi-task model; and masking, to obtain answer data that correspond to the question data and that are output by the question answering task branch, data corresponding to the second branch parameter when data are generated at each neural network layer in the multi-task model and transferred to a next neural network layer, comprises:
when the question processing data indicates that the question data satisfy a predetermined need, inputting the question data into the multi-task model; and masking, to obtain the answer data that correspond to the question data and that are output by the question answering task branch, the data corresponding to the second branch parameter when data are generated at each neural network layer in the multi-task model and transferred to the next neural network layer.

16. The non-transitory, computer-readable medium of claim 14, wherein inputting the question data into the multi-task model; and masking, to obtain answer data that correspond to the question data and that are output by the question answering task branch, data corresponding to the second branch parameter when data are generated at each neural network layer in the multi-task model and transferred to the next neural network layer, comprises:
obtaining a second mask vector corresponding to the first branch parameter;
performing, based on the second mask vector and to mask a parameter matrix comprising a branch parameter other than the first branch parameter, a second mask operation on a parameter matrix comprising a branch parameter of each task branch in the multi-task model at each neural network layer; and
inputting, to obtain the answer data, the question data into the multi-task model obtained after the second mask operation is performed.

17. A computer-implemented system for multi-task model training, comprising:
one or more computers; and
one or more computer memory devices interoperably coupled with the one or more computers and having tangible, non-transitory, machine-readable media storing one or more instructions that, when executed by the one or more computers, perform one or more operations, comprising:
obtaining a trained multi-task model comprising at least a question answering task branch, wherein a parameter of the multi-task model comprises a basic parameter and a first branch parameter corresponding to the question answering task branch, and wherein the first branch parameter is a parameter for adjusting the basic parameter;
when an instruction for detecting output data of the question answering task branch is received:
adding a task detection branch to the multi-task model; and
obtaining a training corpus set, wherein the training corpus set comprises a plurality of training texts and a label that is of each training text and that corresponds to a prediction result of detection content in the instruction;
inputting training text into the multi-task model;
masking, to obtain a prediction result that corresponds to the training text and that is output by the task detection branch, data corresponding to the first branch parameter of the question answering task branch when data are generated at each neural network layer in the multi-task model and transferred to a next neural network layer; and
adjusting, to obtain a trained multi-task model, a second branch parameter of the task detection branch based on the label and the prediction result that corresponds to the training text, wherein the second branch parameter is a parameter for adjusting the basic parameter.

18. The computer-implemented system of claim 17, wherein;
inputting training text into the multi-task model; and masking, to obtain a prediction result that corresponds to the training text and that is output by the task detection branch, data corresponding to the first branch parameter of the question answering task branch when data are generated at each neural network layer in the multi-task model and transferred to a next neural network layer, comprises:
obtaining a first mask vector corresponding to the second branch parameter;
performing, based on the first mask vector and to mask a parameter matrix comprising a branch parameter other than the second branch parameter, a first mask operation on a parameter matrix comprising a branch parameter of each task branch in the multi-task model at each neural network layer; and
inputting, to obtain the prediction result, the training text into the multi-task model obtained after the first mask operation is performed.

19. The computer-implemented system of claim 18, wherein, before adjusting the second branch parameter:
performing, to obtain a first parameter submatrix and a second parameter submatrix, low-rank decomposition on a parameter matrix comprising the second branch parameter, wherein a quantity of rows of the first parameter submatrix is identical to a quantity of columns of the second parameter submatrix, a quantity of columns of the first parameter submatrix is identical to a quantity of columns of the parameter matrix, and a quantity of rows of the second parameter submatrix is identical to a quantity of rows of the parameter matrix.

20. The computer-implemented system of claim 19, wherein performing, based on the first mask vector, and to mask a parameter matrix comprising a branch parameter other than the second branch parameter, a first mask operation on a parameter matrix comprising a branch parameter of each task branch in the multi-task model at each neural network layer, comprises:
multiplying, to obtain a product parameter matrix comprising the second branch parameter, the first parameter submatrix by the second parameter submatrix; and
performing, to mask a parameter matrix comprising a branch parameter other than the product parameter matrix, the first mask operation on a first parameter matrix and the product parameter matrix at each neural network layer in the multi-task model.
